(19) United States
(12) Patent Application Publication
(10) Pub. No.: US 2018/0247250 A1
(43) Pub. Date: Aug. 30, 2018

(54) SYSTEM AND METHOD FOR TRANSMITTING PEER PERFORMANCE EVALUATION DATA

(71) Applicant: Kanger Shum, San Francisco, CA (US)

(72) Inventor: Kanger Shum, San Francisco, CA (US)

(21) Appl. No.: 15/889,025

(22) Filed: Feb. 5, 2018

Related U.S. Application Data
(60) Provisional application No. 62/456,244, filed on Feb. 8, 2017.

(51) Int. Cl. G06Q 10/06; G07C 13/00

(52) U.S. Cl. CPC G06Q 10/06398; H04L 67/10; G07C 13/00

(57) ABSTRACT

A system for peer performance evaluation includes a mobile device for peer performance evaluation. By means of a voting page displayed on the mobile device, users evaluate co-workers' job performance in a number of categories. The mobile device, communicatively coupled to a cloud server, uploads the performance data to the server. At the server, the performance data may be downloaded to a user device as a performance profile for the particular user, which is displayed on a performance profile page. The performance profiles are portable, allowing an employee to use the profile as evidence of his/her qualifications. The employer may make use of employee performance data and voting history data as inputs to an employee incentive program. Incentives may be displayed on a rewards page on the mobile device. The employer may make further use of the performance data to identify workstyles conducive to the employer's mission and culture.

### CROSS REFERENCE TO RELATED APPLICATIONS

This application claims benefit of U.S. provisional patent application Ser. No. 62/456,244, filed Feb. 8, 2017, the entirety of which is incorporated herein.

### BACKGROUND

### Technical Field

The present disclosure relates to systems for management of human resources data. More particularly, the present disclosure relates to a system and method for transmitting peer performance evaluation data.

### Background Information

Employee performance evaluations are an extremely widespread tool for developing employees and fostering organizational effectiveness. A typical performance review is a face-to-face interview between an employee and one or more supervisors. Generally, performance reviews are done on an annual or a semiannual basis. There has developed a small industry around the process of performance evaluation. There is much debate and difference of opinion regarding the best way to do a performance evaluation. Employers may spend large amounts of money sending their management personnel to third-party training seminars in performance evaluation. An additional expense of the seminars is the loss of the managers' time from attending the seminars.

There is also a large body of published literature on the proper way to conduct a performance evaluation. Use of these materials, again, can require a significant investment of management time and money that provides a very uncertain, difficult-to-quantify benefit in terms of employee performance and corporate effectiveness.

This performance evaluation industry has developed in response to the fact that performance evaluation, considered to be an essential human-resource management tool, is difficult to do well, is extremely time-consuming and is very uncomfortable for both the employee being evaluated and the evaluator. Additionally, when performance evaluation is not performed well it can be extremely demotivating for employees, ultimately having the exact opposite effect that it is intended to have.

Another shortcoming of the conventional performance evaluation is that, because it is a face-to-face interview that consists largely of subjective, qualitative assessments of an employee's job performance and discussion thereof, it doesn't yield much hard data that the organization can use, for example, to design and conduct employee incentive programs or to identify the work styles that are most supportive of the company's business goals. Also, the highly-subjective nature of the performance evaluation prevents it from providing information about an employee that future employers of the subject employee would find useful in determining whether he/she would be a good hire for them.

### SUMMARY

A system for peer performance evaluation includes a mobile device for peer performance evaluation. By means of a voting page displayed on the mobile device, users evaluate co-workers' job performance in a number of categories. The mobile device, communicatively coupled to a cloud server, uploads the performance data to the server. At the server, the performance data may be downloaded to a user device as a performance profile for the particular user, which is displayed on a performance profile page. The performance profiles are portable, allowing an employee to use the profile as evidence of his/her qualifications. The employer may make use of employee performance data and voting history data as inputs to an employee incentive program. Incentives may be displayed on a rewards page on the mobile device. The employer may make further use of the performance data to identify workstyles conducive to the employer's mission and culture.

### BRIEF DESCRIPTION OF THE DRAWINGS

FIG. 1 provides a screenshot of a voting page from a user interface of a mobile device for peer performance evaluation;

FIG. 2 provides a schematic diagram of a system for peer performance evaluation;

FIG. 3 is a diagram illustrating data flows in the system of FIG. 2 during a peer performance review process;

FIG. 4 provides a chart of the data generated as a result of the peer performance review process

FIG. 5 provides a screenshot of a user profile from a user interface of a mobile device for peer performance evaluation;

FIG. 6 is a diagram illustrating data flows in the system of FIG. 2 that generate the user profile of FIG. 5;

FIG. 7 provides a screenshot of a prize collection page from a user interface of a mobile device for peer performance evaluation;

FIG. 8 is a diagram illustrating data flows in the system of FIG. 2 for awarding prizes for exceptional employee performance;

FIG. 9 is a diagram illustrating data flows in the system of FIG. 2 for extracting data from employee profiles for generating insights to guide future hiring; and

FIG. 10 provides a network architecture diagram for the system of FIG. 2.

### DETAILED DESCRIPTION

A system for peer performance evaluation includes a mobile device for peer performance evaluation. By means of a voting page displayed on the mobile device, users evaluate co-workers' job performance in a number of categories. The mobile device, communicatively coupled to a cloud server, uploads the performance data to the server. At the server, the performance data may be downloaded to a user device as a performance profile for the particular user, which is displayed on a performance profile page. The performance profiles are portable, allowing an employee to use the profile as evidence of his/her qualifications. The employer may make use of employee performance data and voting history data as inputs to an employee incentive program. Incentives may be displayed on a rewards page on the mobile device. The employer may make further use of the performance data to identify workstyles conducive to the employer's mission and culture.

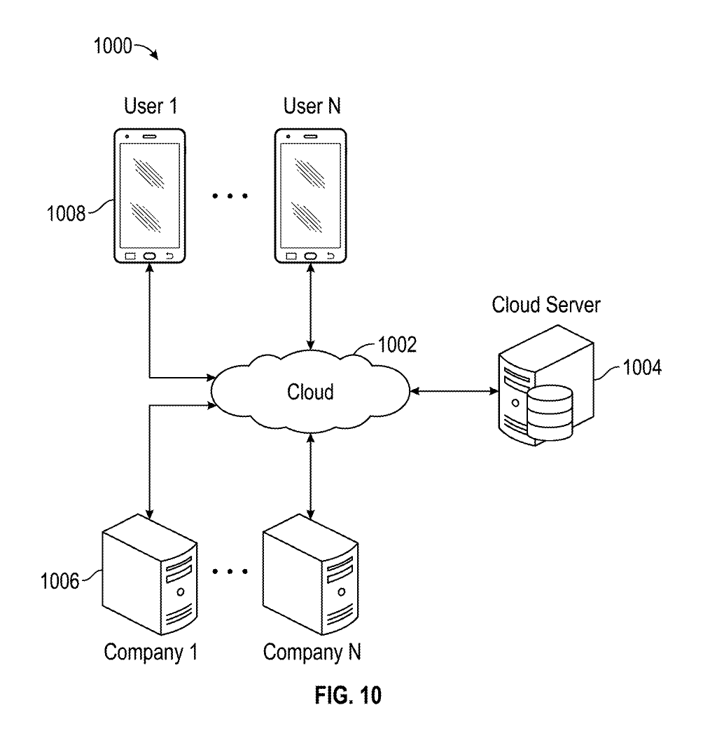

Referring now to FIG. 10, shown is a network architecture diagram of a system 1000 for peer performance evaluation. One of more user devices 1008 are communicatively coupled to a cloud server 1004. One or more servers 1006 associated to employer companies are also communicatively coupled to the cloud server. As described in greater detail herein below, the user device 1008 may constitute a mobile device 204 for peer performance evaluation, wherein the mobile device 204 is programmed to allow the user to enter peer performance data via a user interface displayed on the mobile device 204. Additionally, by means of the user interface, the user can view and interact with his/her own performance data entered by other users.

After the data is entered by way of the mobile device 204, it is transmitted via a network connection to the cloud server 1004. In embodiments, the network connection may be either a wired or wireless connection. The companies 1006 may also view and interact with the performance data in ways that are described in greater detail herein below.

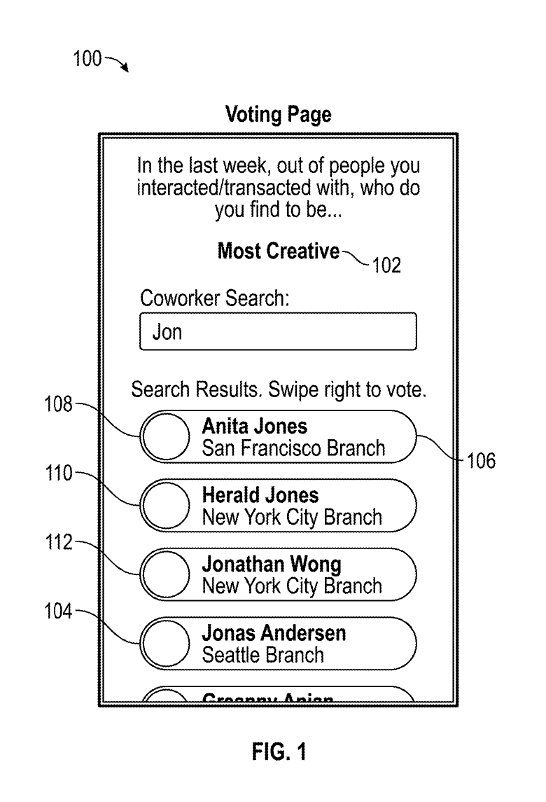

FIG. 1 shows a screenshot of a voting page 100 from a mobile application running on a mobile device 204. By interacting with the voting page 100, the user is able to enter performance appraisal information for his/her co-workers. In embodiments, the user may enter performance appraisal information for any employee in the company. In embodiments, the user may enter performance appraisal information for a predetermined subset of his/her co-workers.

In embodiments, the voting page presents the user with sequence of questions. For example, as shown, the user is prompted to answer the question, “In the last week, out of people you interacted/transacted with, who you find to be most creative” 102. A ‘search’ field 104 accepts user input and displays a set of results based on the user input.

In embodiments, the user may enter his/her selection by swiping right 106, as shown. Other means of entering the user selection are possible.

In embodiments, an avatar such as a miniature photograph of the user appears next to his/her name 108. In embodiments, the name of the co-worker matching the query is shown 110. The part of the coworker's name that matches the query may be shown in bold text, or may otherwise be emphasized in some way. In embodiments, the search results also may include the branch with which a co-worker is associated 112.

When swiping is complete, the next voting category may be presented for voting, for example, “friendliest.” It will be appreciated that the voting categories are a matter of design choice and may be configured by the employer/administrator of the system.

When voting is complete, a summary page appears for confirmation. If the ballot is confirmed, the user presses a ‘confirm’ button.

If any vote needs to be modified, the user may simply swipe left and a re-vote page will appear.

Activating the ‘confirm’ button transmits the ballot to the cloud server, whereupon it is stored in a database associated to the employer.

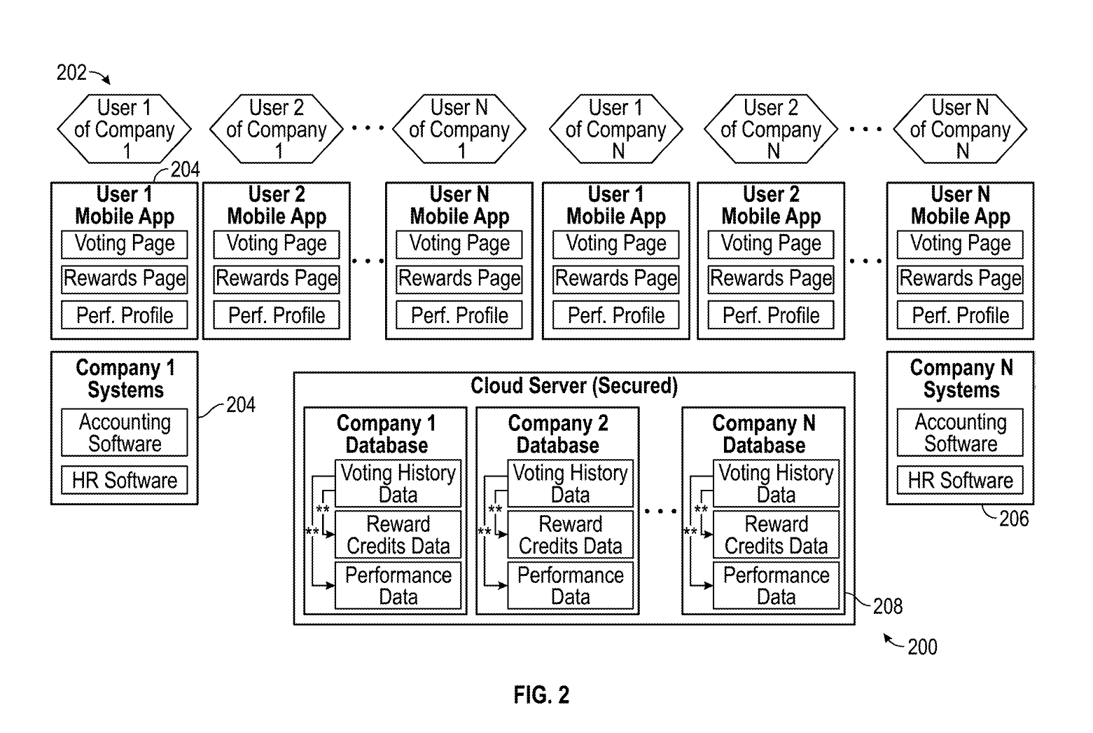

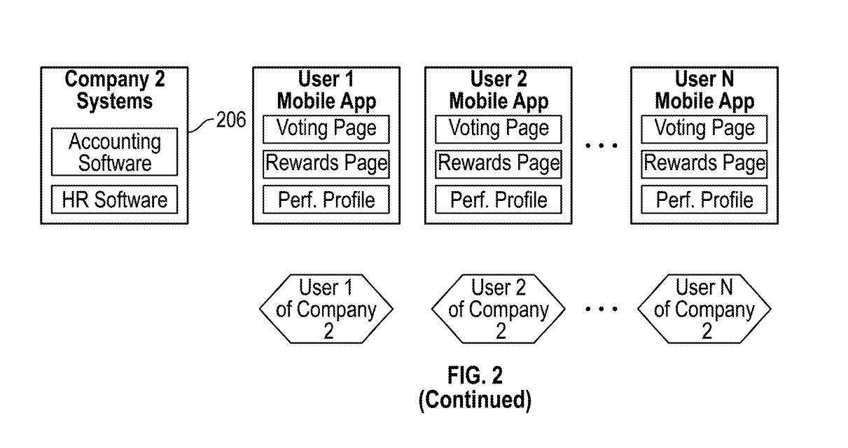

Turning now to FIG. 2 shown is an architecture diagram of a system for peer performance evaluation. As shown in FIG. 2, there exist primary stakeholders in the system: individual users 202 and the companies 206 who employ the users. Associated to each user 202 is a mobile device 204 for peer performance evaluation. Installed on each device 204 is an application for peer performance evaluation.

Included within the application for peer performance evaluation are:
a voting page 100;
a rewards page 700; and
a performance profile 500.

In embodiments, a cloud server 208 serves as the data store for the data generated by the peer performance appraisal process. In embodiments, the cloud server stores separate databases associated to each company 206. As shown in FIG. 2, voting history data is received from each of the devices 204. Votes are tallied for each user of each company. Credits are increased for each user based on the number of votes received. Performance data is also modified to incorporate votes from the most recent voting session.

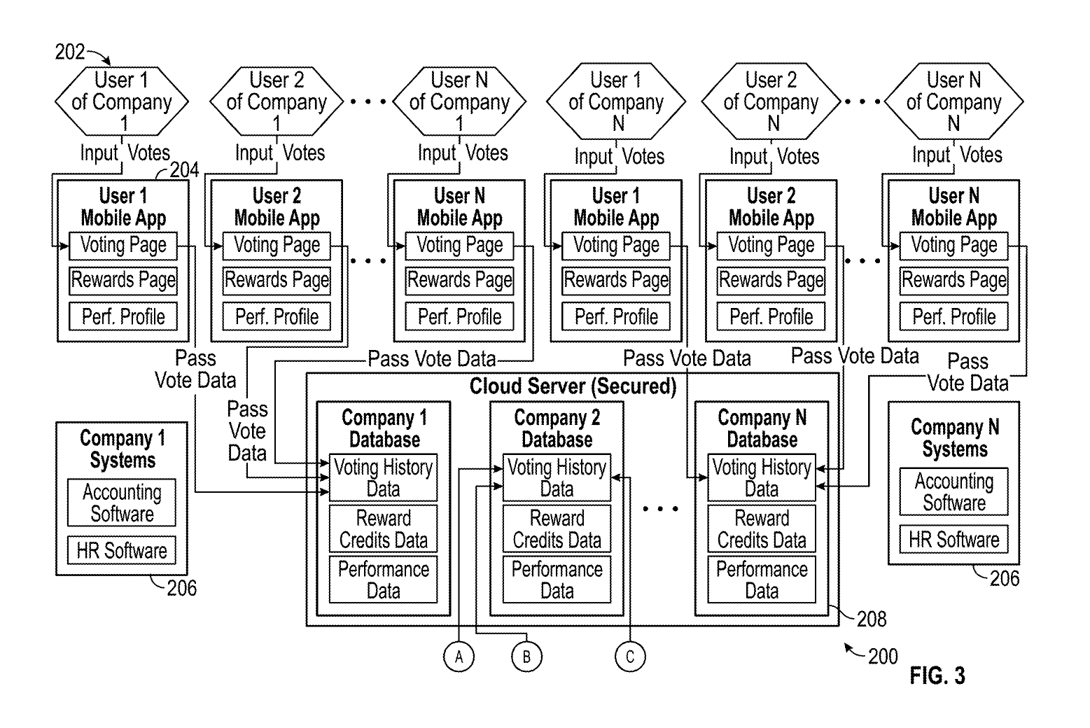

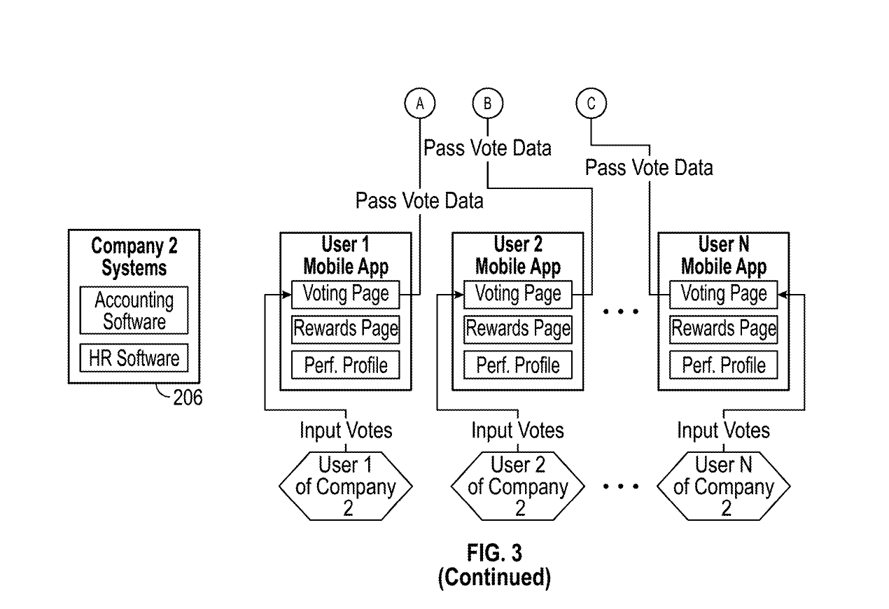

FIG. 3 shows illustrates the flow of newly-entered voting data. As the user enters voting data on the mobile device, the data is periodically transmitted to the cloud server. In embodiments, voting data is transmitted to the cloud server 208 each time the user 202 confirms his/her vote by means of the voting page 100.

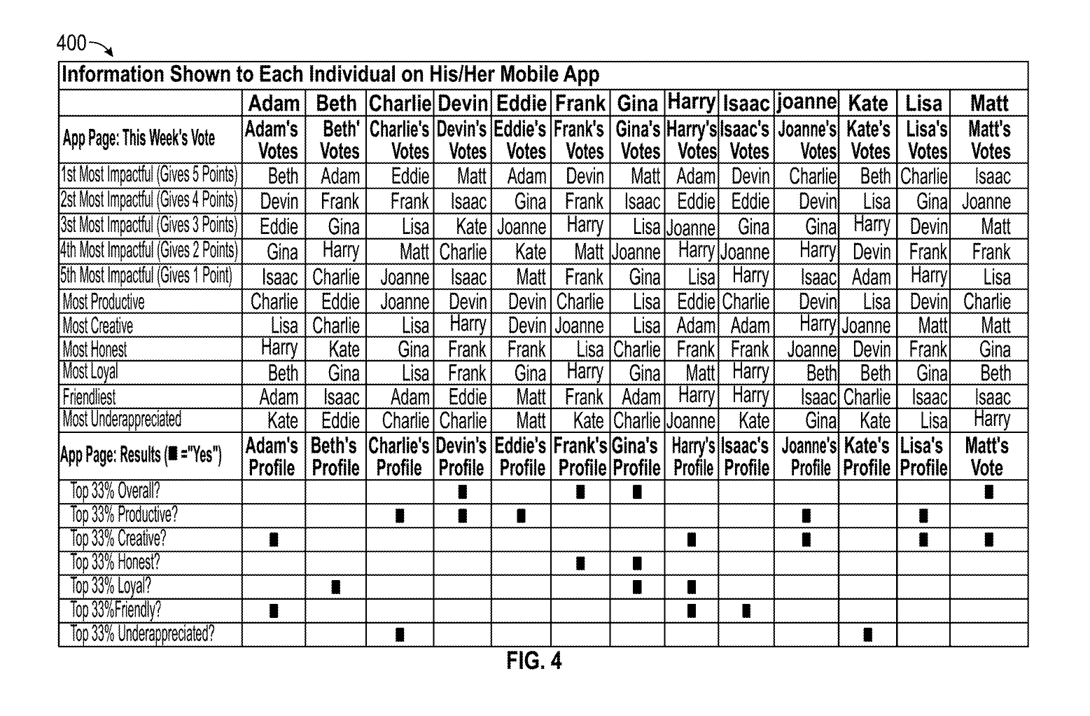

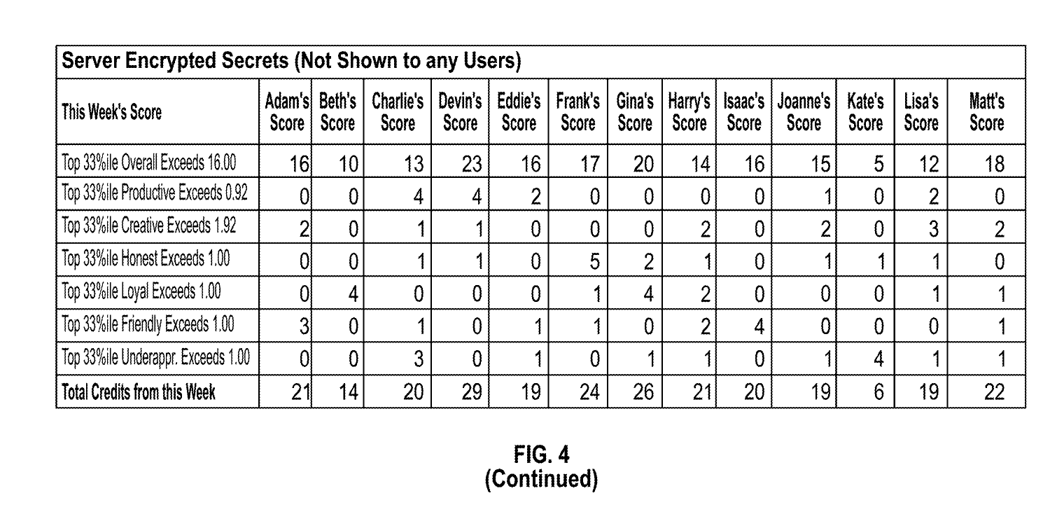

FIG. 4 shows a table of information 400 shown to each user in the user interface on his/her mobile device 204. Each column corresponds to an individual user. For example, the leftmost user column of the table shows user Adam's voting record, as displayed to him on his mobile device 204.

The voting categories are a matter of design choice and may be selected by the individual company according to its own criteria.

Directly under Adam's name are listed the names of the people for whom he has voted in the current round of voting. Beneath Adam's votes is shown Adam's performance profile for the current round of voting. As shown, Adam was in the top 33% for “most creative,” and also for “most friendly.”

As previously described, when votes are tallied at the cloud server, the individual user is assigned credits based on his/her performance profile. Adam's score for the current voting session was 16. He was granted 5 additional credits for being in the top 33% in two separate voting categories.

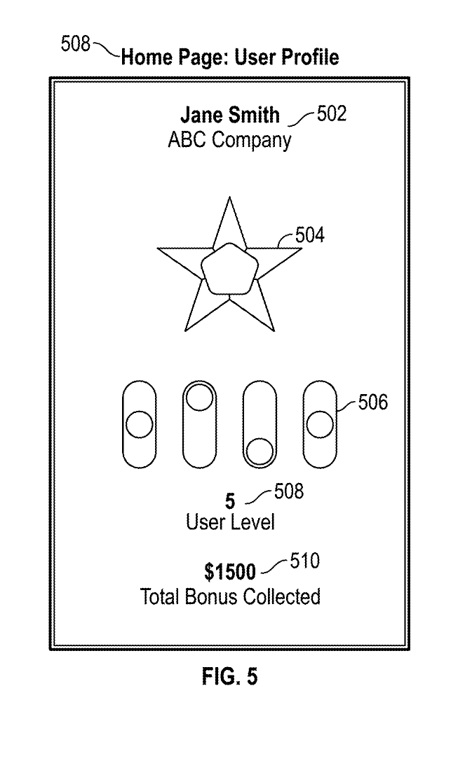

FIG. 5 shows a user profile 500 from the user interface of the mobile device 204. In embodiments, the user profile may include one or more of:
User's name and Company 502;
A star icon, in which different parts may be lit up and/or dimmed according to which area the employee is performing in the top 33% 504;
A plurality of switches for expressing user preferences 506;
How many times the user has leveled-up his/her app 508; and
The total bonuses the user has collected 510

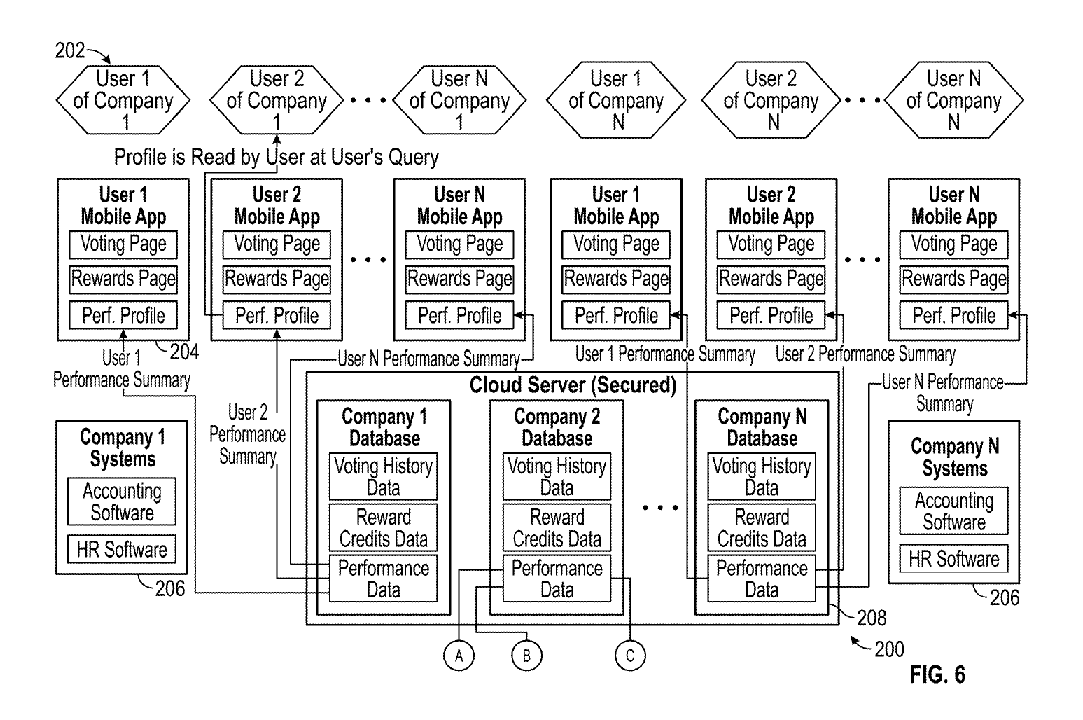

FIG. 6 diagrams the flow of performance data. As shown in FIG. 2, reward credits data and performance data are based on the raw voting history data. When the cloud server 208 has generated the voting history data and the performance data, it is transmitted back to each user's mobile device 204 and displayed to the user as the performance profile 500

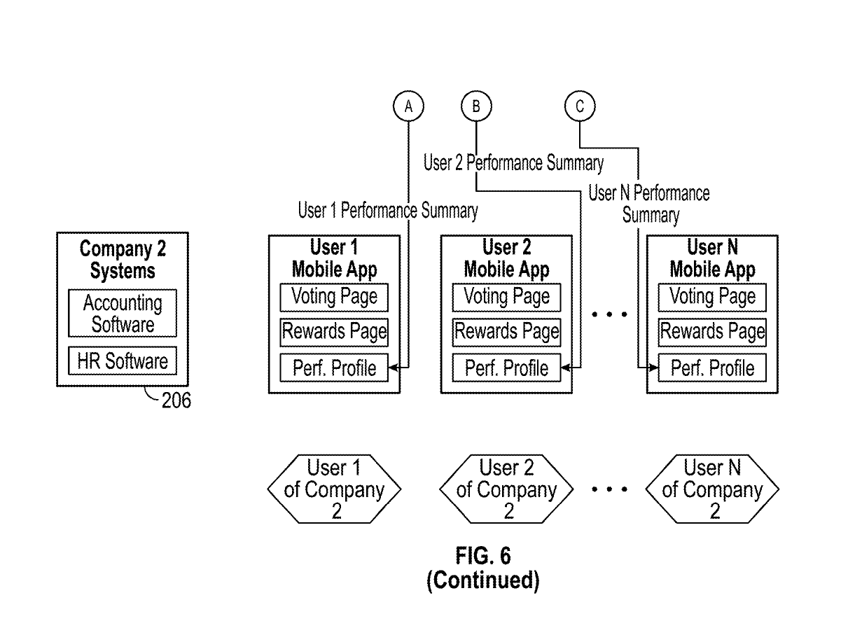

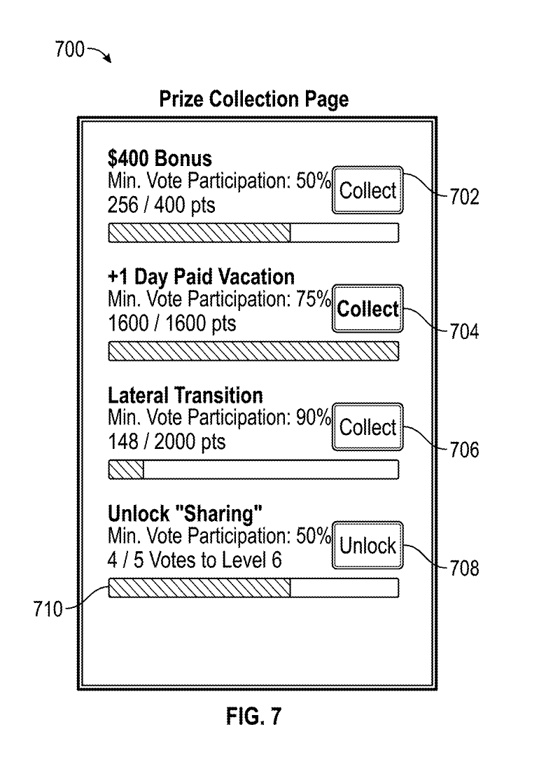

FIG. 7 shows a prize collection page 700 from the user interface of the user device 204. The prize collection page describes a number of prizes 702-708 which may be awarded to the user, depending on his/her performance and voting history. The actual prizes are a matter of design choice and are a reflection of the employer's culture and mission.

Here, a bar 710 shows the user's progress toward collection of a prize. As shown in FIG. 7, for example, the user has accrued enough points to qualify for a day of paid vacation. The user may activate a ‘collect’ button to collect the prize. Once the user activates the collect button, the progress bar is reset.

In addition to points, the user must satisfy the minimum vote participation to qualify for the prize. For example, the user, in order to qualify for the paid vacation, needed to accrue 1600 points, but also needed to have a vote participation of at least 75% for the previous 12 voting sessions in order to collect the prize. Thus, prizes are keyed both to job performance and to participation in the voting process.

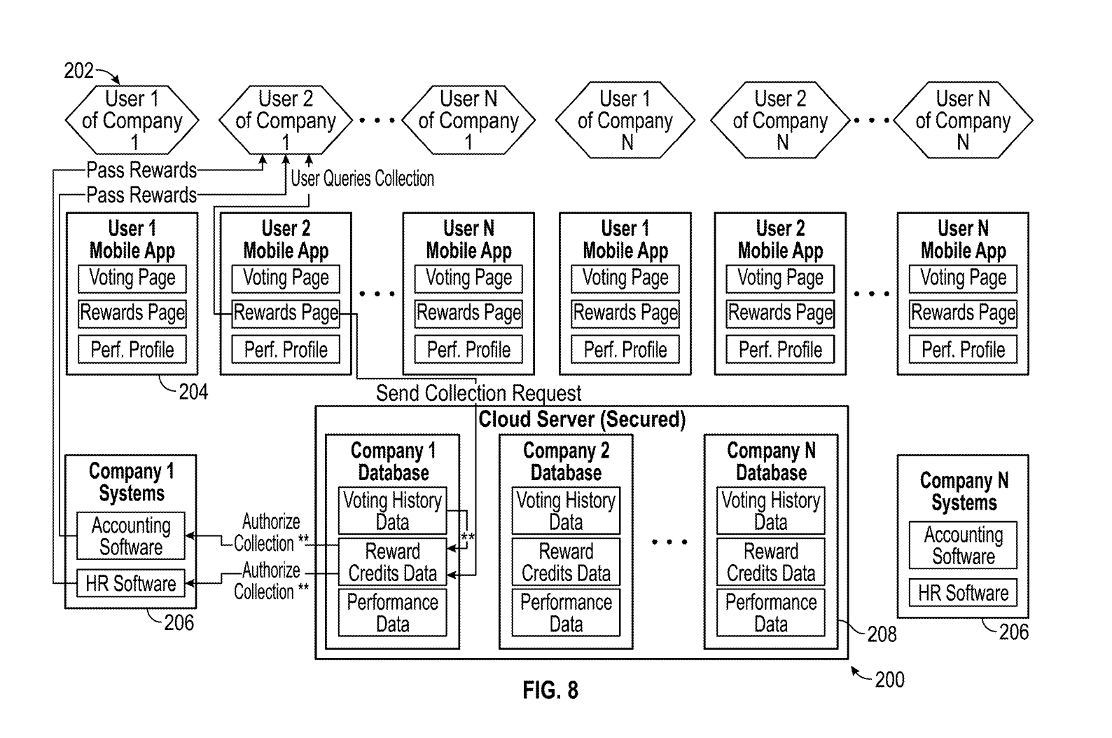

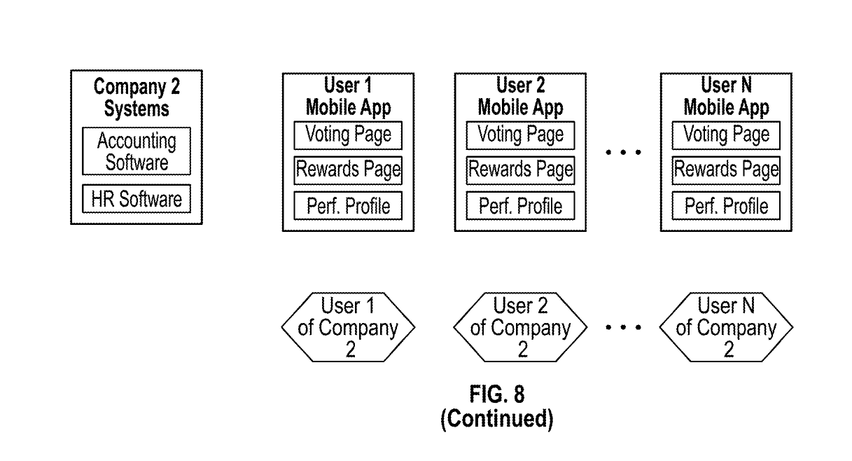

FIG. 8 shows the data flow for collection of prizes by the user. . As shown above in FIG. 7, when a user has satisfied that conditions for a prize, a ‘collect’ button 704, previously greyed out, lights up in the UI and may be activated by the user. Activating the ‘collect’ button has the effect of directing a query to the cloud server 208 to verify that the necessary conditions for awarding the prize are satisfied. First the voting history data, and then the reward credits data are queried to verify that the necessary conditions for awarding the prize are satisfied:
That the average voting participation of the user exceeds a predetermined percentage for that prize; and
That the user has accumulated enough credits for the prize.

If both conditions are satisfied, the cloud server directs an authorization to both the accounting program and the HR management program at the company, whereupon, the company awards the prize to the user.

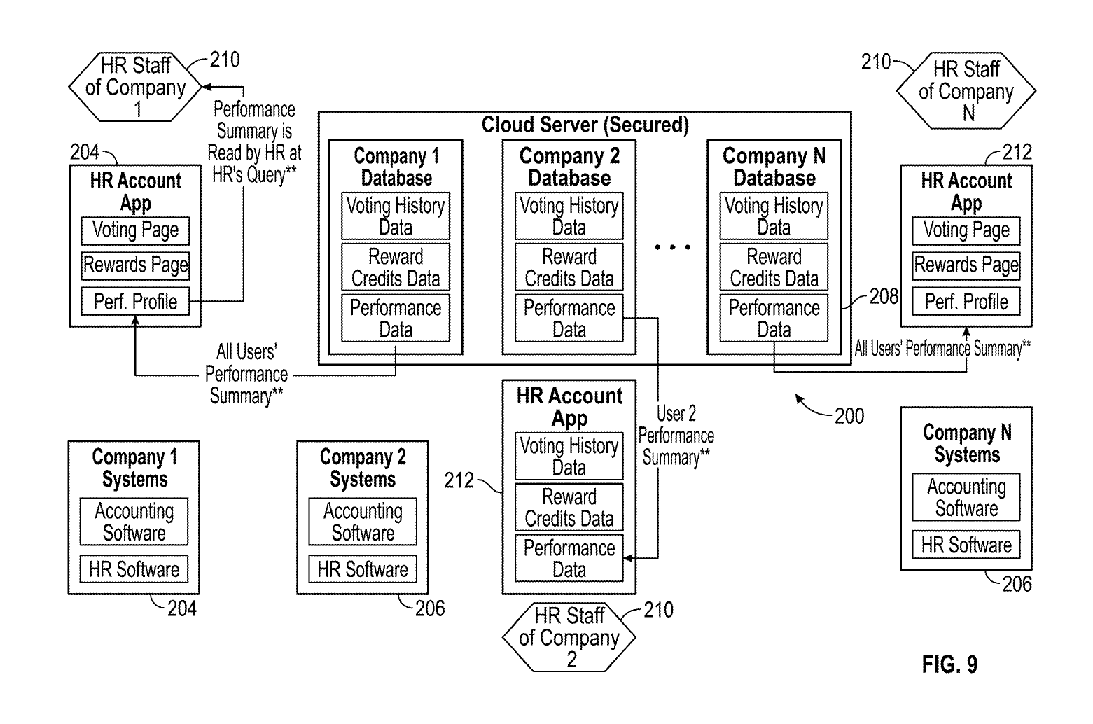

FIG. 9 illustrates data flows in which the company queries the performance data. Aside from simple performance summaries of individual users, shown in relation to user 2, the company can query performance data for all users in order to derive certain insights. For example, the cloud server can show correlation profiles of which workstyles are most closely correlated with performance and retention for the company as a whole, or for each position.

### Third Party Verifiability of Talent

Technical Problem

Currently in the open job market, the only common vehicles for communicating a jobseekers qualifications are (1) their resume both in the physical and digital form e.g. LINKEDIN profile, MONSTER.COM profile and so on, (2) references from previous employers, (3) the interview process both by phone and in person, and (4) key performance indicators (KPIs) generated internally within a company. All of these vehicles have their own shortcomings.

The limitation of a resume is that a resume is usually seen by employers as something that is self-professed. It lacks credibility because it lacks third party-verification. Often times there is subjective information provided in a resume such as “[I was] critical in the successful completion of the big project.” The degree of importance and commitment is not verifiable even if the events such as the “big project” are verifiable. Furthermore, the jobseeker's interpersonal and leadership skills are even more difficult to believe than technical knowledge from a resume.

LINKEDIN (LINKEDIN Corp., Mountain View, Calif.) tries to solve these issues with a function that allows other users to verify the qualifications of other users. However, there are still limitations to this. A broader personal LINKEDIN network or more friends on LINKEDIN would naturally lead to more verifications of more qualifications. Over time there is no mechanism for these verifications of qualifications to degrade or be amended for more recent information. In other words, once one friend makes a verification, it is permanent and final, even though skills and performance are never truly permanent nor final.

Currently, when reviewing a jobseeker's resume, it is common to find references from the jobseeker's previous employers. The first limitation of such reference is that it can take a lot of time to gather all necessary references. Another limitation is that the individuals making the references are either hand-selected by the jobseeker, which represents biased information, or a random individual that might not know of the jobseeker's performance at a sufficiently intimate level.

Interviews with the jobseeker are commonly used as a method to further determine qualifications. The first limitation of interviews is its relatively high cost, mostly from the labor of having HR and technical managers meet and speak with the jobseeker. Most candidates that are interviewed are not even those that ultimately hold the employment position.

Common Key Performance Indicator systems in a company are set up to allow easy performance comparison of one employee with another employee of the same position, or within the same department, or in the same industry. However, it is often necessary to compare employee performances from cross-boundaries, so that KPI's (specified to their narrow purpose) are not helful in providing a direct comparison. This prevents companies from gaining further confidence in lateral employment transitions for employees in a company.

Technical Solution

The system provides a new digital platform to convey qualifications. The system creates 3 new properties for conveying qualification:

(1) it makes qualifications instantly and continuously verifiable by third party,

(2) it greatly reduces the time and cost of attaining a critical level of confidence in a jobseeker's qualifications, and

(3) it presents a brief and singular summary of the jobseeker through a democratized opinion process.

In other words, the system bypasses many of the shortcomings of the aforementioned platforms. A software application, most likely offered as a cellular mobile application (Mobile App), allows all coworkers in a company to vote for other coworkers who performed remarkably. The data representing the votes is transmitted to the cloud server. Upon being received at the cloud server, the votes are preprocessed, for example by being tallied digitally, and the digital information is near instantaneously rearranged to create a performance profile of the employee, as shown in FIG. 5 according to one or more stored formats. If the employee should leave that position and becomes a jobseeker, this performance profile can later be used as a verified qualification for the jobseeker to share with companies with which they are seeking an employment position.

Unlike a resume, the performance profile is third party verified since it is a tallying of votes given from previous coworkers. Also unlike a resume, the performance profile includes a third-party verified score for the jobseeker's interpersonal skills in addition to technical qualifications and job experience.

Unlike the skills verification function of LINKEDIN, the system actually keeps track of changes over time and provides for a constantly updated and most recent representation of a jobseeker's current performance. Because it is vote based, and the number of votes each coworker can give is constant, there is a natural decay and disappearance of their verified qualifications, if these qualifications should indeed disappear in the jobseeker's most recent performance.

Unlike the current method of calling previous coworkers/employers for references, the system does not have the strong biases that may result from the hand selection of references by the jobseeker. It also does not encounter the problem of getting information from a generalized HR department, which may not know the jobseeker's performance intimately, and may even have ulterior motives for providing biased information. The system provides information gleaned from a democratized process, information which is a wide average of many coworkers' opinions. Unlike both the process of calling for references and the process of phone/face-to-face interviews, this system provides critical, high-quality information without the lengthy time and resource investment. This system allows for the use of dramatically either fewer interviews to find the appropriate talent.

Unlike the use of Key Performance Indicators (KPIs) this system creates a platform for qualification comparison of employees of different positions, different departments, and even different industries. With this system, companies can make lateral transitions with employees with much more confidence for success.

```
Pseudo Code for Tallying Points
      User uses Mobile App's voting page to make a series of votes for other employees. The
      Voting Page allows the Voter to search by name for the employee for which they want to
      vote for under each category (Overall Impact, Productivity, Creativity, Honesty, Loyalty,
      Friendliness). After each vote, the Mobile App will prompt the user for the next category
      of voting. This repeats until the Voter has completing voting for all categories. The user
      voting input raw data will be transferred to the Cloud Server for computing. It is on the
      Cloud Server that the below pseudo code runs.
      See Fig. 1 for Mobile App's Voting Page.
      See Fig. 2 for Tabular Representation of Tallying Mechanism completed by Cloud
      Server.
      User.PointsCurrentImpact = This week's total points given to the user for overall
      impact.
      User.VotesCurrentProductive = This week's total votes given to the user for
      Productivity.
      User.VotesCurrentCreative = This week's total votes given to the user for Creativity.
      User.VotesCurrentHonest = This week's total votes given to the user for Honesty.
      User.VotesCurrentLoyal = This week's total votes given to the user for Loyalty.
      User.VotesCurrentFriendly = This week's total votes given to the user for Friendliness.
      User.WeeklyVotes(weeks,6) = 2 Dimensional Matrix representing one user. Each row
      in the matrix represents another week of voting. Column-1 values represent overall
      performance votes. Column-2 values represent productivity votes. Column-3 values
      represent creativity Votes. Column-4 values represent honesty votes. Column-5 values
      represent loyalty votes. Column-6 values represent friendliness votes. This matrix keeps
      growing non-stop with new rows added to the bottom with each passing week.
      User.NumRows = rows(User.WeeklyVotes) **This line creates a variable in the class
      variable User, called NumRows that stores a whole number representing the number of
      rows in the matrix.
      Resize(WeeklyVotes,NumRowsPreviousWeek+1,6). **This increases the size of matrix
      Weekly Votes by 1 row.
      User.NumRows = User.NumRows+1
      User.WeeklyVotes[User.NumRows][1] = User.PointsCurrentImpact
      User.WeeklyVotes[User.NumRows][2] = User.VotesCurrentProductive
      User.WeeklyVotes[User.NumRows][3] = User.VotesCurrentCreative
      User.WeeklyVotes[User.NumRows][4] = User.VotesCurrentHonest
      User.WeeklyVotes[User.NumRows][5] = User.VotesCurrentLoyal
      User.WeeklyVotes[User.NumRows][6] = User.VotesCurrentFriendly
      User.VotesLast12[1] = User.WeeklyVotes[User.NumRows][1] +
      User.WeeklyVotes[User.NumRows-1][1] + User.WeeklyVotes[User.NumRows-2][1] +
      User.WeeklyVotes[User.NumRows-3][1] + ... + User.WeeklyVotes[User.NumRows-
      11][1]
      User.VotesLast12[2] = User.WeeklyVotes[User.NumRows][2] +
      User.WeeklyVotes[User.NumRows-1][2] + User.WeeklyVotes[User.NumRows-2][2] +
      User.WeeklyVotes[User.NumRows-3][2] + ... + User.WeeklyVotes[User.NumRows-
      11][2]
      User.VotesLast12[3] = User.WeeklyVotes[User.NumRows][3] +
      User.WeeklyVotes[User.NumRows-1][3] + User.WeeklyVotes[User.NumRows-2][3] +
      User.WeeklyVotes[User.NumRows-3][3] + ... + User.WeeklyVotes[User.NumRows-
      11][3]
      User.VotesLast12[4] = User.WeeklyVotes[User.NumRows][4] +
      User.WeeklyVotes[User.NumRows-1][4] + User.WeeklyVotes[User.NumRows-2][4] +
      User.WeeklyVotes[User.NumRows-3][4] + ... + User.WeeklyVotes[User.NumRows-
      11][4]
      User.VotesLast12[5] = User.WeeklyVotes[User.NumRows][5] +
      User.WeeklyVotes[User.NumRows-1][5] + User.WeeklyVotes[User.NumRows-2][5] +
      User.WeeklyVotes[User.NumRows-2][5] + ... + User.WeeklyVotes[User.NumRows-
      11][5]
      User.VotesLast12[6] = User.WeeklyVotes[User.NumRows][6] +
      User.WeeklyVotes[User.NumRows+1][6] + User.WeeklyVotes[User.NumRows-2][6] +
      User.WeeklyVotes[User.NumRows-2][6] + ... + User.WeeklyVotes[User.NumRows-
      11][6]
      TotalUsers = Total Number of Users in the Company
      SixtySixthPoint = Round(TotalUsers * 0.66) **Rounds TotalUsers variable to nearest
      whole number
Pseudo Code for Determining Top 33 Percentile Performers
      After tallying the votes, the Cloud Server will determine the quantity of votes representing
      the divide between the top 33 percentile and the rest. For each category for which a
      User is a top 33 percentile performer, the Server will mark them as a top 33 percentile
      performer. Meanwhile the User's Mobile App will show areas in which they received the
      top 33 percentile mark.
      See Fig. 2 for a tabulated representation of Users getting marks for different areas for
      which they are top 33 percentile performers.
      66thPercentileImpact = Variable that holds the statistical value of the 66th percentile of
      User.VotesLast12[1] for all Users.
      66thPercentileProductive = Variable that holds the statistical value of the 66^{th} percentile
      of User.VotesLast12[2] for all Users.
      66thPercentileCreative = Variable that holds the statistical value of the 66^{th} percentile of
      User.VotesLast12[3] for all Users.
      66thPercentileHonest = Variable that holds the statistical value of the 66^{th} percentile of
      User.VotesLast12[4] for all Users.
      66thPercentileLoyal = Variable that holds the statistical value of the 66^{th} percentile of
      User.VotesLast12[5] for all Users.
      66thPercentileFriendly = Variable that holds the statistical value of the 66^{th} percentile of
      User.VotesLast12[6] for all Users.
      NumUsers = Total Number of Users in a company
      For(i = 1 to NumUsers)
      {
            If(User[i].VotesLast12[1] > 66thPercentileImpact)
            {
                  User[i].IsTopImpact = True
            }
      } **This Loop and If statement runs through all Users in a company to find those with
      Impact Points greater than the 66the percentile impact points mark and sets those Users
      to an IsTopImpact value of True.
      For All users with IsTopImpact set to True, the mobile app will light up the portion of the
      Performance “star” graphic corresponding to Overall Impact.
      For(i = 1 to NumUsers)
      {
            If(User[i].VotesLast12[2] > 66thPercentileProductive)
            {
                  User[i].IsTopProductive = True
            }
      } **This Loop and If statement runs through all Users in a company to find those with
      Productivity Votes greater than the 66the percentile Productivity Votes mark and sets
      those Users to an IsTopProductive value of True.
      For All users with IsTopProductive set to True, the mobile app will light up the portion of
      the Performance “star” graphic corresponding to Productivity.
      For(i = 1 to NumUsers)
      {
            If(User[i].VotesLast12[3] > 66thPercentileCreative)
            {
                  User[i].IsTopCreative = True
            }
      } **This Loop and If statement runs through all Users in a company to find those with
      Productivity Votes greater than the 66the percentile Creativity Votes mark and sets those
      Users to an IsTopCreative value of True.
      For All users with IsTopCreative set to True, the mobile app will light up the portion of the
      Performance “star” graphic corresponding to Creativity.
      For(i = 1 to NumUsers)
      {
            If(User[i].VotesLast12[4] > 66thPercentileHonest)
            {
                  User[i].IsTopHonest = True
            }
      } **This Loop and If statement runs through all Users in a company to find those with
      Productivity Votes greater than the 66the percentile Honesty Votes mark and sets those
      Users to an IsTopHonest value of True.
      For All users with IsTopHonest set to True, the mobile app will light up the portion of the
      Performance “star” graphic corresponding to Honesty.
      For(i = 1 to NumUsers)
      {
            If(User[i].VotesLast12[5] > 66thPercentileLoyal)
            {
                  User[i].IsTopLoyal = True
            }
      } **This Loop and If statement runs through all Users in a company to find those with
      Loyalty Votes greater than the 66the percentile Loyalty Votes mark and sets those Users
      to an IsTopLoyal value of True.
      For All users with IsTopLoyal set to True, the mobile app will light up the portion of the
      Performance “star” graphic corresponding to Loyalty.
      For(i = 1 to NumUsers)
      {
            If(User[i].VotesLast12[6] > 66thPercentileFriendly)
            {
                  User[i].IsTopFriendly = True
            }
      } **This Loop and If statement runs through all Users in a company to find those with
      Friendliness Votes greater than the 66the percentile Friendliness Votes mark and sets
      those Users to an IsTopFriendly value of True.
      For All users with IsTopFriendly set to True, the mobile app will light up the portion of the
      Performance “star” graphic corresponding to Friendly.
      After all determinations are made by the Cloud Server on whether each user is in the top
      33 percentile, the individual User Mobile Apps will have their statuses summarized on
      their profile. See Fig. 3 for Mobile App's Profile Page.
```

### Managing Rewards

Technical Problem and Technical Solution

Companies have historically relied on bonus-style benefits to align employee incentives with overall company and owner incentives. However the current conventional system of bonuses has many pitfalls including: (1) unfair, unclear, and hurtful comparisons, (2) fussy or poor metrics, (3) lack of clarity in calculation, (4) bonus inflation, (5) excessive concentration of bonuses at the top of the organization, (6) poor measurement of the effects of bonuses on each individual, (6) employees being interested in the rewards but not interested in the process of determining performance. Almost everyone who has ever received a bonus has participated in or witnessed the subsequent comparison of bonuses among coworkers. Despite that fact that no two employees bring the same commitment, qualification, and circumstances to the table, the differences in bonus values tends to create a strong feeling of unfairness among the employees as someone invariably feels that should be given the same bonus value as someone else. This situation is intense because often times most bonuses are passed out at around the same time in a company. That is, the frequency of bonuses is constant among employees, but the magnitude of the bonus is variable among employees. The system reverses this convention. It makes the bonus magnitude constant; however, the frequency by which employees receive the bonuses is variable. Since employees will be receiving bonuses at times that are unpredictable by other employees, there may be substantially fewer instances in which one employee would be motivated to inquire about another employee's bonuses. Even if they were to inquire, the response would be that they are receiving the same bonus value. It would be much more difficult and would require a lot more analysis to be able to share the frequency of the bonuses with each other. Also, as the frequencies themselves may vary with an employee based on this/her performance, it is difficult to even report on a certain frequency to another employee, all but eradicating the unfair, unclear, and hurtful comparisons that often ensue after conventional sessions of bonus distribution.

In a conventional bonus system, some sort of metric is ordinarily used to determine the employee's bonuses. These metrics are often wrought with issues and inefficiencies. The first is that all positions typically require different metrics. The second is that oftentimes the metrics used require a process of measurement and the process of measurement is often costly. This creates waste that otherwise could go into increasing employee bonuses. The system resolves many of these issues. The system works for all positions: an accountant may be voted for (graded) in the same way as a janitor. The system also incorporates an inexpensive means for measuring. There is no need for another manager to keep track of metrics. There is no need for special machines to measure the number of products created. There is no need for clocks to measure cycle times.

In a conventional bonus system, employees often are unaware as to the mechanism for calculation. They often do not understand how various performance metrics are calculated into factors that ultimately determine their bonus value. This is especially true when employees change position within a company or when new employees are hired who have to be trained to understand the metrics. Because The system uses the same simple system of accumulating credits that are a simple sum of votes regardless of the employee's position, they will know and continue to know how their bonuses are calculated regardless of what position or what company they end up in. The system is designed to become a standard in the employment world where the calculation may be universally understood, even when employees change companies.

In a conventional bonus system, employees often adapt by learning how to take advantage of the bonus system. They figure out ways to quickly improve performance metrics, with less and less real value contribution to the organization. This leads to increasing total payouts to employees over time for the company, often without increasing value added to the organization. This is one avenue by which bonuses exhibit inflationary behavior. Another avenue by which bonuses inflate is that employees become accustomed and demanding of a certain bonus. When they do not receive this value in the next cycle of bonus distribution, their motivation drops. The system largely avoids this problem because the bonus value is already set to be constant; it is nearly entirely within an employee's power to determine how frequently he/she will receive each round of bonuses.

In many organizations, setting the concentration of bonuses poses a dilemma. If the organization allows the “pot” of bonuses to be distributed among all employees, the actual bonus payouts would be so small as to have little to no impact on behavior. Often, organizations conclude that in order to make the value of the bonus actually impactful to the behavior of any individual, they have to distribute it among fewer people, usually at the upper levels of the organizational hierarchy. This often means that the lower levels of the organization, which often are the drivers of company success by creating/providing the company's primary product and service, are left without a bonus whatsoever. The system, because it has such strong gamification properties, can lead to pronounced behavioral changes in all employees. Thus, the system encourages companies to expand the territory of those eligible for bonuses to include more employees than with a conventional bonus system.

Next, conventional bonus systems cannot provide much data on the behavioral consequences of the bonuses. For example, they cannot predict or estimate what effect $10,000 of bonuses has on an employee's performance or how long those effects last. And they definitely cannot give insight on character change of the employees during the different phases of imminence of collecting a bonus. These effects include, how long-lasting are the bonuses' effects on performance, and how powerful are the bonuses' effects on performance. This invention would store all pertinent data necessary to answer these critical questions about incentive alignment and would eventually provide those insights to the companies that use the invention.

Lastly, in conventional bonus systems and peer reviews, employees are typically far more interested in their own rewards than in contributing to the quality and completeness of the reviews. What t this system does is that it requires a minimum level of voting participation from an employee in the recent voting sessions in order for that employee to be eligible to collecting the rewards. In other words, even when the credits needed for the reward has been achieved, the employee cannot collect until they bring up their participation percentage to a minimum level set by the company using the app. This system thus solves one of the biggest issues with a democratic process, which is low levels of voting participation.

```
Psuedo Code for Increasing Credits Towards Rewards
      At the end of each round of voting and after the votes have been tallied, they would
      generate credits that could be redeemed for Rewards (usually in the form of employment
      benefits) to the Employee receiving the votes.
      Two examples of such benefits is a bonus and an additional day of paid vacation for the
      year.
      The follow psuedo code would run on the Cloud Server.
      BonusGoal = Required credits to collect bonus
      VacayGoal = Required credits to collect vacation
      User.CreditsTowardsBonus = User.CreditsTowardBonus + User.PointsCurrentImpact +
      User.VotesCurrentProductive + User.PointsCurrentCreative + User.PointsCurrentHonest
      + User.PointsCurrentLoyal + User.PointsCurrentFriendly
      If (User.CreditsTowardsBonus >= BonusGoal)
      {
            User.CreditsTowardsBonus = BonusGoal
      } **This code sets an upper limit for the variable User.CreditsTowardsBonus
      User.CreditsTowardsVacay = User.CreditsTowardsVacay + User.PointsCurrentImpact
      + User.VotesCurrentProductive + User.PointsCurrentCreative +
      User.PointsCurrentHonest + User.PointsCurrentLoyal + User.PointsCurrentFriendly
      If (User.CreditsTowardsVacay >= VacayGoal)
      {
            User.CreditsTowardsBonus = VacayGoal
      } **This code sets an upper limit for the variable User.CreditsTowardsVacay
Psuedo Code for Collecting Rewards
      The Mobile App will update all User statuses in terms of which Rewards would be
      available for collecting based on the credits reported to the Mobile App from the Cloud
      Server. Those rewards available for collecting would have graphical indication such as a
      color-lit button showing that it would be enabled for pressing. Once pressed, the rewards
      would be collected. This pseudo code would run on the Mobile App for Users to collect
      rewards.
      See Fig. 4 for the Mobile App's Reward Collection page.
      If ((User.CreditsTowardsBonus >= BonusGoal) && (User.Participation > .75))
      {
            User.CollectBonusButtonEnable = True
      }
      Else{ User.CollectBonusButtonLit = False} **User Mobile apps will have prize collection
      enabled only when two conditions are met. The first is that their accumulated credits
      towards the bonus reward reaches the goal set by the Company. The second is that their
      percentage participation in voting in the last 12 company voting sessions is greater than a
      percentage set by the company.
      If ((User.CreditsTowardsVacay >= VacayGoal) && (User.Participation > .85))
      {
            User.CollectVacayButtonEnable = True
      }
      Else{ User.CollectVacayButtonLit = False} **User Mobile apps will have prize collection
      enabled only when two conditions are met. The first is that their accumulated credits
      towards the vacation reward reaches the goal set by the Company. The second is that
      their percentage participation in voting in the last 12 company voting sessions is greater
      than a percentage set by a company.
      If (User.CollectBonusButtonEnable = True && User.CollectBonusButton = “Click”)
      {
            PayableBonus = PayableBonus + BonusSize
            User.CreditsTowardsBonus = 0
      } ** This code increases the Users payable bonuses by the standard size of the bonus set
      by the company, but only allows it if the collect bonus button is both enabled and pressed
      by the User. Once collected the accumulated credits are reset to zero for further
      accumulation.
      If (User.CollectVacayButtonEnable = True && User.CollectVacayButton = “Click”)
      {
            UnusedVacayDays = Unused VacayDays + 1
            User.CreditsTowardsVacay = 0
      } ** This code increases the Users remaining unused paid vacation days by 1, but only
      allows it if the collect vacation button is both enabled and pressed by the User. Once
      collected the accumulated credits are reset to zero for further accumulation.
```

Hiring Insights Drawn from Data

Technical Problem and Technical Solution

All human resource departments or personnel in companies constantly struggle to determine the correct hiring strategy. They are often most concerned with determining which work styles in candidates are going to be the greatest drivers of (1) performance and (2) retention. Companies are interested in performance for obvious reasons, but they are interested in retention because, when retention is increased, the cost of re-training, cost of new documentation, the cost of resume reviews and interviews can all be decreased. Lastly (3), companies want to know which work styles are drivers to performance and retention for particular positions. Conventionally, companies have difficulty gaining a singular summary of which work styles drive performance and which work styles drive retention. This leads to a nebulous and expensive strategy for companies to follow when hiring. The system gives companies unprecedented insight toward answering these two important questions.

Companies struggle to determine which work styles to pursue when hiring in order to generate the greatest benefit to overall performance. A company conventionally depends on vague sociological findings that are not necessarily specific to its industry, its organization, and its circumstances relative to the current instance in time. The current tools available to them are essentially qualitative in nature. They learn from comparing project performances or task performances of separate invididuals, usually at an anecdotal level. Often, there's either no quantitative measurement of an employee's work style, or there's no quantitative measurement of the employees overall performance, or even neither. The system changes this playing field by essentially taking periodic and constantly-updated measurements of the employee's work styles as well as their overall performance. From this raw data the system can determine which work styles (productivity, creativity, honesty, loyalty, friendliness) are the strongest drivers of performance. Using the findings of this system, the HR department can increase its hiring preference for jobseekers that more strongly exhibit those work styles.

Companies also struggle to determine which work-styles lead to longer careers; or in other words, which work styles benefit employee retention the most. Likewise with deciphering the work styles that drive performance, a company conventionally depends on vague sociological findings that are not specific to its industry, its organization, and its circumstances for the present time. The current tools available to them are also essentially qualitative in nature. They learn from stories about which individuals (with which work styles) have in the past functioned as examples of an employee that remained employed for a long time. Again, usually there's either no quantitative measurement of the employee's work style, or there's no quantitative statistical io measurement of employment duration, or even neither. This system essentially takes periodic and updating measurements of the employee's work styles as well as their duration of employment. From this raw data, this system can determine which work styles are the strongest drivers of high retention. Using the findings of this system, the HR department can increase its hiring preference for jobseekers that more strongly is exhibit those work styles.

Companies have difficulty determining beyond broad sociological findings and common sense which work styles are drivers of performance and retention for each position. It is apparent that one set of work styles would be strong drivers of performance and retention for one set of responsibilities, but a potentially different set of work styles could be drivers for a different set of responsibilities. This system can also sort its data and analysis to determine which work styles are the most appropriate for each type of position in a company.

```
Psuedo Code for Finding drivers of Performance
      PerformanceMatrix(NumUsers,6) = 2-Dimensional matrix storing the last 12 weeks votes.
      PerformanceMatrix[i][1] = User[i].VotesLast12[1] **Sets Performance Matrix's first
      column to all Users' overall impact points from the last 12 weeks.
      PerformanceMatrix[i][2] = User[i].VotesLast12[2] **Sets Performance Matrix's second
      column to all Users' productivity votes from the last 12 weeks.
      PerformanceMatrix[i][3] = User[i].VotesLast12[3] **Sets Performance Matrix's third
      column to all Users' creativity votes from the last 12 weeks.
      PerformanceMatrix[i][4] = User[i].VotesLast12[4] **Sets Performance Matrix's fourth
      column to all Users' honesty votes from the last 12 weeks.
      PerformanceMatrix[i][5] = User[i].VotesLast12[5] **Sets Performance Matrix's fifth
      column to all Users' loyalty votes from the last 12 weeks.
      PerformanceMatrix[i][6] = User[i].VotesLast12[6] **Sets Performance Matrix's sixth
      column to all Users' friendliness votes from the last 12 weeks.
      CorrelPerfProductive = Correlation coefficient (R squared) of trend line of all scatter
      points (x,y), where x = PerformanceMatrix[i][2] and y = PerformanceMatrix[i][1].
      CorrelPerfCreative = Correlation coefficient (R squared) of trend line of all scatter points
      (x,y), where x = PerformanceMatrix[i][3] and y = PerformanceMatrix[i][1].
      CorrelPerfHonest = Correlation coefficient (R squared) of trend line of all scatter points
      (x,y), where x = PerformanceMatrix[i][4] and y = PerformanceMatrix[i][1].
      CorrelPerfLoyal = Correlation coefficient (R squared) of trend line of all scatter points
      (x,y), where x = PerformanceMatrix[i][5] and y = PerformanceMatrix[i][1].
      CorrelPerfFriendly = Correlation coefficient (R squared) of trend line of all scatter points
      (x,y), where x = PerformanceMatrix[i][6] and y = PerformanceMatrix[i][1].
      SlopePerfProductive = Slope of trend line of all scatter points (x,y), where x =
      PerformanceMatrix[i][2] and y = PerformanceMatrix[i][1].
      SlopePerfCreative = Slope of trend line of all scatter points (x,y), where x =
      PerformanceMatrix[i][3] and y = PerformanceMatrix[i][1].
      SlopePerfHonest = Slope of trend line of all scatter points (x,y), where x =
      PerformanceMatrix[i][4] and y = PerformanceMatrix[i][1].
      SlopePerfLoyal = Slope of trend line of all scatter points (x,y), where x =
      PerformanceMatrix[i][5] and y = PerformanceMatrix[i][1].
      SlopePerfFriendly = Slope of trend line of all scatter points (x,y), where x =
      PerformanceMatrix[i][6] and y = PerformanceMatrix[i][1].
      Company.CorrelationProfile = 2-dimensional vector in the class Company that holds all
      coefficient variables of the Company.
      Company.CorrelationProfile[1][1] = CorrelPerfProductive * SlopePerfProductive
      Company.CorrelationProfile[1][2] = CorrelPerfCreative * SlopePerfCreative
      Company.CorrelationProfile[1][3] = CorrelPerfHonest * SlopePerfHonest
      Company.CorrelationProfile[1][4] = CorrelPerfLoyal * SlopePerfLoyal
      Company.CorrelationProfile[1][5] = CorrelPerfFriendly * SlopePerfFriendly
      This CorrelationProfile can be shared between companies of the same industry to give
      insightful information to Member Companies. See next section for Row 2 of
      Company.CorrelationProfile.
Psuedo Code for Determining Drivers of Retention
      CorrelRetenProductive = correlation coefficient of trend line of all scatter points (x,y),
      where x = PerformanceMatrix[i][2] and y = User.DaysEmployed.
      CorrelRetenCreative = correlation coefficient of trend line of all scatter points (x,y),
      where x = PerformanceMatrix[i][3] and y = User.DaysEmployed.
      CorrelRetenHonest = correlation coefficient of trend line of all scatter points (x,y), where
      x = PerformanceMatrix[i][4] and y = User.DaysEmployed.
      CorrelRetenLoyal = correlation coefficient of trend line of all scatter points (x,y), where x
      = PerformanceMatrix[i][5] and y = User.DaysEmployed.
      CorrelRetenFriendly = correlation coefficient of trend line of all scatter points (x,y),
      where x = PerformanceMatrix[i][6] and y = User.DaysEmployed.
      SlopeRetenProductive = Slope of Trendline for scattered points (x,y) where x =
      PerformanceMatrix[i][2] and y = User.DaysEmployed
      SlopeRetenCreative = Slope of Trendline for scattered points (x,y) where x =
      PerformanceMatrix[i][3] and y = User.DaysEmployed
      SlopeRetenHonest = Slope of Trendline for scattered points (x,y) where x =
      PerformanceMatrix[i][4] and y = User.DaysEmployed
      SlopeRetenLoyal = Slope of Trendline for scattered points (x,y) where x =
      PerformanceMatrix[i][5] and y = User.DaysEmployed
      SlopeRetenFriendly = Slope of Trendline for scattered points (x,y) where x =
      PerformanceMatrix[i][6] and y = User.DaysEmployed
      Company.CorrelationProfile = 2-dimensional vector in the class Company that holds all
      coefficienct variables of the Company.
      Company.CorrelationProfile[2][1] = CorrelRetenProductive * SlopeRetenProductive
      Company.CorrelationProfile[2][2] = CorrelRetenCreative * SlopeRetenCreative
      Company.CorrelationProfile[2][3] = CorrelRetenHonest * SlopeRetenHonest
      Company.CorrelationProfile[2][4] = CorrelRetenLoyal * SlopeRetenLoyal
      Company.CorrelationProfile[2][5] = CorrelRetenFriendly * SlopeRetenFriendly
      This CorrelationProfile can be shared between companies of the same industry to give
      insightful information to Member Companies. See previous section for Row 1 of
      Company.CorrelationProfile.
Psuedo Code for Determining Drivers of Positional Success
      The Company creates an exhaustive list of positions inside the company. Each
      Employee's Mobile Account is created with data about which position the Employee is in.
      This information about position will be used by the Cloud Server to determine which work
      styles are the strongest drivers of performance and retention specific to each position.
      Find correlation profile for all Positions in the Server with the For Loop below:
      For(i=1 to NumPositions)
      {
            PositionMatrix[i][2]
            RowCount = 0
            For(j=1 to NumUsers)
            {
                  If(User[j].Title = PositionMatrix[i][2])
                  {
                        RowCount = RowCount +1
                        Resize(DataToCorrelate[RowCount,6)
                        DataToCorrelate[RowCount][1] = User
                        DataToCorrelate[RowCount][2]
                        DataToCorrelate[RowCount][3]
                        DataToCorrelate[RowCount][4]
                        DataToCorrelate[RowCount][5]
                        DataToCorrelate[RowCount][6]
                  }
            }
      CorrelPerfProductive = Correlation coefficient R_squared between overall
      impact and productivity for all scatter points (x,y) where x = DataToCorrelate[i][2]
      and y = DataToCorrelate[i][1]
      CorrelPerfCreative = Correlation coefficient R_squared between overall impact
      and creativity for all scatter points (x,y) where x = DataToCorrelate[i][3] and y =
      DataToCorrelate[i][1]
      CorrelPerfHonest = Correlation coefficient R_squared between overall impact
      and honesty for all scatter points (x,y) where x = DataToCorrelate[i][4] and y =
      DataToCorrelate[i][1]
      CorrelPerfLoyal = Correlation coefficient R_squared between overall impact and
      loyalty for all scatter points (x,y) where x = DataToCorrelate[i][5] and y =
      DataToCorrelate[i][1]
      CorrelPerfFriendly = Correlation coefficient R_squared between overall impact
      and friendliness for all scatter points (x,y) where x = DataToCorrelate[i][6] and y =
      DataToCorrelate[i][1]
      SlopePerfProductive = Slope of Trendline for scattered points (x,y) where x =
      DataToCorrelate[i][2] and y = DataToCorrelate[i][1]
      SlopePerfCreative = Slope of Trendline for scattered points (x,y) where x =
      DataToCorrelate[i][3] and y = DataToCorrelate[i][1]
      SlopePerfHonest = Slope of Trendline for scattered points (x,y) where x =
      DataToCorrelate[i][4] and y = DataToCorrelate[i][1]
      SlopePerfLoyal = Slope of Trendline for scattered points (x,y) where x =
      DataToCorrelate[i][5] and y = DataToCorrelate[i][1]
      SlopePerfFriendly = Slope of Trendline for scattered points (x,y) where x =
      DataToCorrelate[i][6] and y = DataToCorrelate[i][1]
      PositionMatrix[i][3] = CorrelPerfProductive
      PositionMatrix[i][4] = CorrelPerfCreative
      PositionMatrix[i][5] = CorrelPerfHonest
      PositionMatrix[i][6] = CorrelPerfLoyal
      PositionMatrix[i][7] = CorrelPerfFriendly
      PositionMatrix[i][8] = SlopePerfroductive
      PositionMatrix[i][9] = SlopePerfCreative
      PositionMatrix[i][10] = SlopePerfHonest
      PositionMatrix[i][11] = SlopePerfLoyal
      PositionMatrix[i][12] = SlopePerfFriendly
      PositionMatrix[i][13] = CorrelRetenProductive
      PositionMatrix[i][14] = CorrelRetenCreative
      PositionMatrix[i][15] = CorrelRetenHonest
      PositionMatrix[i][16] = CorrelRetenLoyal
      PositionMatrix[i][17] = CorrelRetenFriendly
      PositionMatrix[i][18] = SLopeRetenProductive
      PositionMatrix[i][19] = SLopeRetenCreative
      PositionMatrix[i][20] = SLopeRetenHonest
      PositionMatrix[i][21] = SLopeRetenLoyal
      PositionMatrix[i][22] = SLopeRetenFriendly
      PositionMatrix[i][23] = CorrelPerfProductive * SlopePerfProductive
      PositionMatrix[i][24] = CorrelPerfCreative * SlopePerfCreative
      PositionMatrix[i][25] = CorrelPerfHonest * SlopePerfHonest
      PositionMatrix[i][26] = CorrelPerfLoyal * SlopePerfLoyal
      PositionMatrix[i][27] = CorrelPerfFriendly * SlopePerfFriendly
      PositionMatrix[i][28] = CorrelRetenProductive * SlopeRetenProductive
      PositionMatrix[i][29] = CorrelRetenCreative * SloperRetenCreative
      PositionMatrix[i][30] = CorrelRetenHonest * SlopeRetenHonest
      PositionMatrix[i][31] = CorrelRetenLoyal * SlopeRetenLoyal
      PositionMatrix[i][32] = CorrelRetenFriendly * SlopeRetenFriendly
}
Below is an Example PositionMatrix:
[ 1][Able Seamen  ][.51][.40][.30][.45][.12] [.32][.45][.32][.14][.16]
[.16][.18][.10][.06][.02] ...
[ 2][Account Manager  ][ ...][ ...][ ...][ ...][ ...] [ ...][ ...][ ...][ ...][ ...] [ ...][ ...][
...][ ...][ ...] ...
[ 3][Accountant ][ ...][ ...][ ...][ ...][ ...] [ ...][ ...][ ...][ ...][ ...] [ ...][ ...][ ...][
...][ ...] ...
[ 4][Actor  ][ ...][ ...][ ...][ ...][ ...] [ ...][ ...][ ...][ ...][ ...] [ ...][ ...][ ...][ ...][
...] ...
[ ...][...  ][ ...][ ...][ ...][ ...][ ...] [ ...][ ...][ ...][ ...][ ...] [ ...][ ...][ ...][
...][ ...] ...
[1014][Skin Care Specialist][ ...][ ...][ ...][ ...][ ...] [ ...][ ...][ ...][ ...][ ...] [ ...][ ...][
...][ ...][ ...] ...
[1015][Slot Key Person  ][.67][.40][.71][.23][.15] [.43][.21][.23][.44][.13]
[.28][.08][.16][.10][.02] ...
Rows of the position matrix can be uploaded to Executive Account Mobile App when
queried. In particular, columns [23] to [32] will be provided as numbers that convey the
level of “importance” each stat is to the expected performance and retention of a certain
position.
```

1. A system for transmitting peer performance evaluation data to selected user devices comprising:
a cloud server, the cloud server comprising a memory and a processor;
the memory containing computer-readable program code for:
receiving data, transmitted from any of a plurality of user devices, representing votes for peer performance appraisals;
receiving data, transmitted from an employer device, representing a score for user participation in a voting program;
pre-processing said received, transmitted data at said cloud server;
formatting said pre-processed data into user performance summaries for one of individual users and at least one group of users according to a stored format;
transmitting any of the performance summaries responsive to requests therefor from any of the user to which a requested performance summary is associated and at least one third party, so that user qualifications are verifiable in real time by the third party;
filtering the user-transmitted data and the employer-transmitted data associated to a particular user by comparing with a predetermined threshold for receiving at least one prize; and
transmitting a result of said comparing;
the system further comprising at least one mobile user device programmed for:
transmitting user-entered data representing the user's votes for peer performance appraisals;
receiving notification of an incoming performance summary;
responsive to receiving notification of the of the incoming performance summary, displaying a performance summary associated to a user of said at least one user device; and
displaying a listing of prizes and the user's qualification for each prize.

2. The system of claim 1, wherein said computer-readable program code comprises computer-readable code for a computer-implemented method for peer performance appraisal wherein a user enters votes concerning a plurality of voting topics regarding job performance of co-workers.

3. The system of claim 1, further comprising a computing device associated to at least one employer, said computing device being communicatively coupled with said cloud server and said at least one mobile user device.

4. The system of claim 3, wherein said computing device is programmed to:
request and receive performance summaries from said cloud server;
receive reports of said comparing from said cloud server; and
transmit data representing a grant of a prize to a selected user to at least one mobile user device associated to the user.

5. The system of claim 1, wherein said at least one mobile user device is programmed to display at least one of:
data representing an associated user's voting history;
data representing an associated user's performance summary; and
data representing an associated user's prizes.

6. The system of claim 1, wherein each user is associated to an employer.

7. The system of claim 6, said cloud server further comprising a data store for each employer subscribing to said system.

8. The system of claim 1, wherein said computing device is programmed for:
constantly updating a most recent representation of a jobseeker's current performance to accurately reflect a natural decay and disappearance of verified qualifications based on voting.

9. The system of claim 1, wherein said at least one mobile user device is programmed to:
present the user with a sequence of questions; and
accept user input comprising answers to individual questions from the sequence of questions.

10. The system of claim 1, wherein said computer-readable program code comprises computer-readable program code for:
taking periodic measurements of an employee's work styles as well as the employee's overall performance;
updating the periodic measurements at at least one predetermined interval; and
comparing the periodic measurements with an index of retention to determine which work styles are the strongest drivers of retention.

11. A mobile device for peer performance evaluation comprising;
a processor;
a memory; and
a display
said memory containing program code for:
transmitting user-entered data representing votes for peer performance appraisals to a server;
displaying a voting history of a user associated to the mobile device
displaying a performance summary associated to the user of the mobile user device; and
displaying a listing of prizes and the user's qualification for each prize.

12. A method for transmitting peer performance evaluation data to selected computing devices comprising:
receiving data at a server, transmitted from any of a plurality of user devices, representing votes for peer performance appraisals;
receiving data at the server, transmitted from an employer device, representing a score for user participation in a voting program;
pre-processing said received, transmitted data at the server;
formatting the pre-processed data into user performance summaries for one of individual users and at least one group of users according to a stored format;
transmitting any of the performance summaries responsive to requests therefor from any of the user to which a requested performance summary is associated and at least one third party, so that user qualifications are verifiable in real time;
filtering the user-transmitted data and the employer-transmitted data associated to a particular user by comparing with a predetermined threshold for receiving at least one prize; and
transmitting a result of the comparing;
the method further comprising:
transmitting from at least one mobile user device user-entered data representing the user's votes for peer performance appraisals;
receiving at the mobile user device notification of an incoming performance summary;
responsive to receiving notification of the of the incoming performance summary, displaying a performance summary associated to a user of the at least one mobile user device; and
displaying a listing of prizes and the user's qualification for each prize.

13. The method of claim 12, further comprising:
requesting and receiving performance summaries from said cloud server by a computing device associated to at least one employer;
receiving reports of said comparing by the computing device associated to the at least one employer from said cloud server; and
transmitting data from the computing device associated to the at least one employer representing a grant of a prize to a selected user to at least one mobile user device associated to the user.

14. The method of claim 12, further comprising:
at a mobile user device, displaying at least one of:
data representing an associated user's voting history;
data representing an associated user's performance summary; and
data representing an associated user's prizes.

15. The method of claim 12, wherein each user is associated to an employer.

16. The method of claim 12, said server including a data store for each employer subscribing to said system.

17. The method of claim 12, further comprising:
updating at constant intervals a most recent representation of a jobseeker's current performance to accurately reflect a natural decay and disappearance of verified qualifications based on voting.

18. The method of claim 12, further comprising:
presenting the user with a sequence of questions; and
accepting user input comprising answers to individual questions from the sequence of questions.

19. The system of claim 12, further comprising:
taking periodic measurements of an employee's work styles as well as the employee's overall performance and retention;
updating the periodic measurements at at least one predetermined interval; and
comparing the periodic measurements with an index of performance to determine which work styles are the strongest drivers of performance.
comparing the periodic measurements with an index of retention to determine which work styles are the strongest drivers of retention.

20. A computer program product for peer performance review comprising program code embodied on a non-transitory medium for:
receiving data at a server, transmitted from any of a plurality of user devices, representing votes for peer performance appraisals;
receiving data at the server, transmitted from an employer device, representing a score for user participation in a voting program;
pre-processing said received, transmitted data at the server;
formatting the pre-processed data into user performance summaries for one of individual users and at least one group of users according to a stored format;
transmitting any of the performance summaries responsive to requests therefor from any of the user to which a requested performance summary is associated and at least one third party, so that user qualifications are verifiable in real time;
filtering the user-transmitted data and the employer-transmitted data associated to a particular user by comparing with a predetermined threshold for receiving at least one prize; and
transmitting a result of the comparing;
the method further comprising:
transmitting from at least one mobile user device user-entered data representing the user's votes for peer performance appraisals;
receiving at the mobile user device notification of an incoming performance summary;
responsive to receiving notification of the of the incoming performance summary, displaying a performance summary associated to a user of the at least one mobile user device; and
displaying a listing of prizes and the user's qualification for each prize.
